(19) United States
(12) Patent Application Publication
(10) Pub. No.: US 2003/0115464 A1
(43) Pub. Date: Jun. 19, 2003

(54) Method of designing password-based authentication and key exchange protocol using zero-knowledge interactive proof

(76) Inventors: Dae Hun Nyang, Inchon (KR); Sok Joon Lee, Taejon (KR); Byung Ho Chung, Taejon (KR)

Correspondence Address: JACOBSON, PRICE, HOLMAN & STERN, PROFESSIONAL LIMITED LIABILITY COMPANY, 400 Seventh Street. N.W., Washington, DC, 20004, US

(21) Appl. No.: 10/066,729

(22) Filed: Feb. 7, 2002

(30) Foreign Application Priority Data
Dec. 19, 2001 (KR) 2001-81105

(51) Int. Cl. H04L 9/00

(52) U.S. Cl. 713/171

(57) ABSTRACT

A protocol designing method that securely performs a password-based authentication and key exchange protocol using a zero-knowledge interactive proof is disclosed. According to this method, various kinds of system parameters required for authentication are first set. Then, a user selects a certain random number in conformity with the set parameters, and sends to a server a message including a user ID, a test number A applying a one-way function, and a first question number generation value X known only to the server and the user. The server, using the message sent from the user, sends to the user a message including an authentication Auth of whether the server possesses a public key, and a second question number generation value Y known only to the server and the user. The user authenticates the server by verifying the authentication Auth, and computes a resultant value c of a secret coin tossing known only to the server and the user and a session key SK. Thereafter, the user sends to the server a witness number B for user authentication. The server that stores a password verifier V for the respective user verifies the witness number B using the value c, and exchanges the session key SK by computing the session key SK. Accordingly, a secure authentication and key exchange can be performed only using the password without the necessity of any tool such as a smart card.

### BACKGROUND OF THE INVENTION

1. Field of the Invention

The present invention relates to a method of performing a key exchange for user authentication and secure communication using a password in a communication network, and more particularly, to a method of designing a password-based authentication and key exchange protocol using the existing zero-knowledge interactive proof. The user can prove his/her identity only by remembering the password without any other tools, and can securely share a session key to be used for the subsequent communication with a server. Here, the user is the subject that performs an authentication request, and the server is the subject that performs the authentication.

2. Background of the Related Art

The user authentication using a password means a procedure in that two subjects participating in the communication confirm if the counterpart is the subject desired to communicate with each other. At this time, any information except for the information required for the user authentication should not be exposed to the counterpart. Also, the key exchange using the password means a procedure in that two subjects participating in the communication share the key. At this time, the shared key should be protected from any eavesdropper.

Also, since the password is very short and its randomness is not so big, being different from a symmetric-key or public-key encryption system, the user authentication and key exchange protocol using the password is liable to be under offline dictionary attacks.

The general zero-knowledge proof has been used for the user authentication, but is not secure if the password is used as the key. However, the present invention provides a method of securely performing the general zero-knowledge proof protocol even if the password is used as the key.

It is known that the currently used authentication protocol is very weak to the offline dictionary attacks. In order to complement this, SRP by Tom Wu, B-SPEKE by David Jacobson, and EKE by Belloving at al have been designed. However, in case of using the password, the security of the existing user authentication protocols has not been mathematically proved. Recently, the security has been proved with respect to a portion of the EKE (encrypted key exchange). Also, protocols having the mathematical security proof have been proposed, but most of them depend on the adhoc design.

Also, in case of using a public key encryption system without using the password in the authentication protocol, the user should possess a security token such as a smart card that stores the user's secret key or note of authentication, causing the user inconvenience. Accordingly, the conventional techniques cannot provide the convenience of the authentication and key exchange protocol using the password.

### SUMMARY OF THE INVENTION

Accordingly, the present invention is directed to a method of designing a password-based authentication and key exchange protocol using a zero-knowledge interactive proof that substantially obviates one or more problems due to limitations and disadvantages of the related art.

It is an object of the present invention to provide a method of designing a password-based authentication and key exchange protocol using a zero-knowledge interactive proof that has a mathematical security proof with respect to the offline dictionary attacks, and enables the design of a systematic password-based authentication protocol without depending on the adhoc design.

It is another object of the present invention to provide a method of designing a password-based authentication and key exchange protocol using a zero-knowledge interactive proof that can perform the user's own authentication and the key exchange by making the user only remember the password when using the password-based authentication and key exchange protocol defined according to the present invention.

In detail, the present invention provides a method of systematically designing the password-based authentication and key exchange protocol using a given zero-knowledge interactive proof. According to the present invention, when a certain zero-knowledge proof is given, it can be converted into a new authentication and key exchange protocol.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a method of designing a password-based authentication and key exchange protocol using a zero-knowledge interactive proof. According to this method, various kinds of system parameters required for authentication are first set. Thereafter, a user selects a certain random number (r, x) in conformity with the set parameters, and sends to a server a message including a user identifier IDᵤₛₑᵣ, a test number A=OWF(r) obtained by applying a one-way function (OWF), and a first question number generation value X known only to the server and the user. The server, using the message sent from the user, sends to the user a message including an authentication Auth of whether the server possesses a public key, and a second question number generation value Y known only to the server and the user. The user authenticates the server by verifying the authentication Auth, and computes a resultant value c of a secret coin tossing known only to the server and the user and a session key SK. The secret coin tossing known only to the server and the user as described above can defend against the offline dictionary attack. After the computation, the user sends to the server a witness number B for user authentication. The server that secretly stores a password verifier V=OWF(f(P)) for the respective user verifies the witness number B using the test number A, the password verifier V, and the value c, and exchanges the session key SK by computing the session key SK. Accordingly, the password-based authentication and the key exchange protocol can be systematically designed using the given zero-knowledge interactive proof.

Also, according to the present invention, the respective password verifiers that cope with an RSA (Rivest, Shamir, Adleman) problem, a discrete logarithm problem, and a prime factorization problem in a framework of FIG. 1 are secretly stored in the server, the user makes the witness numbers B different from one another to cope with the above problems, and makes verification factors different from one another corresponding to the different witness numbers. They will be explained in detail later.

As described above, the present invention provides a method that is capable of easily designing a new authentication and key exchange protocol, and that can be correspondingly applied to various problems without a deep knowledge of encryption and without proposing only one authentication protocol as in the conventional technique.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view illustrating a framework of a user authentication procedure and key exchange algorithm according to the present invention.

FIG. 2 is a view illustrating a protocol for applying an RSA problem to the user authentication procedure and key exchange framework according to the present invention.

FIG. 3 is a view illustrating a protocol for applying a discrete logarithm problem to the user authentication procedure and key exchange framework according to the present invention.

FIG. 4 is a view illustrating a protocol for applying a square root problem based on a prime factorization to the user authentication procedure and key exchange framework according to the present invention.

### DETAILED DESCRIPTION OF THE PREFERRED EMBODIMENTS

The method of designing a password-based authentication and key exchange protocol using a zero-knowledge interactive proof according to the preferred embodiments of the present invention will now be explained in detail with reference to the accompanying drawings.

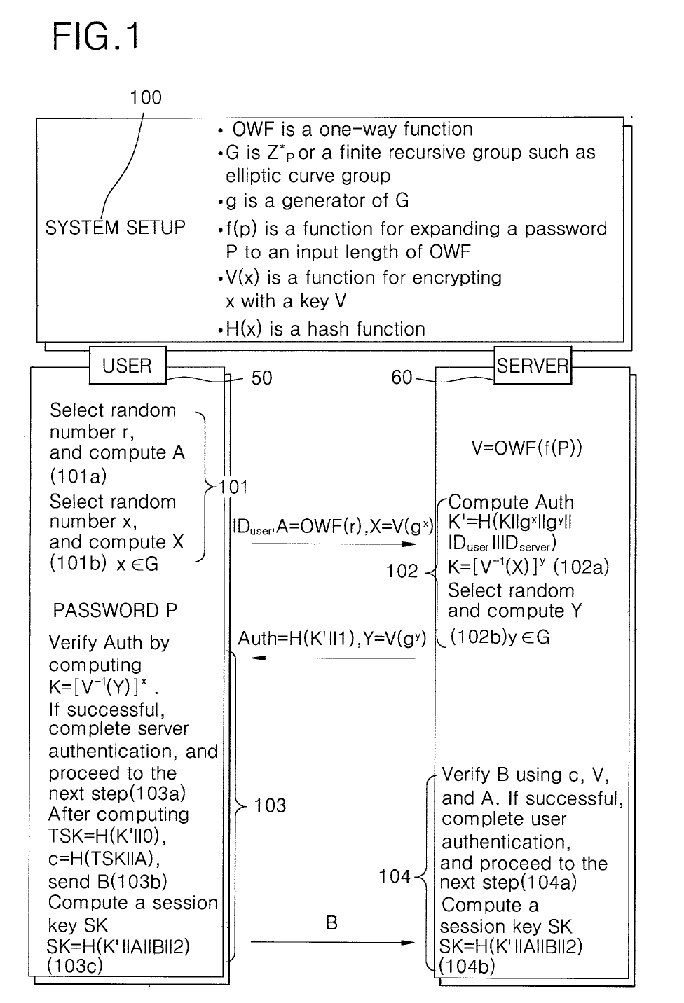

FIG. 1 is a view illustrating a framework of a user authentication procedure and key exchange algorithm according to the present invention.

First, system parameters are preset before a user 50 and a server 60 perform the protocol (step 100). The system parameters are set through the engagement between the user and the server, and the users share the system parameters through the whole system. G is a finite recursive group such as a multiplicative group Z*ₚ or an elliptic curve group, and g is a generator for generating the finite recursive group. For convenience' sake, the present invention follows a multiplicative group notation. OWF is a one-way function. In the embodiments of the present invention, a one-way function based on the RSA (Rivest, Shamir, Adleman) problem, one-way finction based on the discrete logarithm problem, and one-way function based on the prime factorization problem, etc., are described as examples, but the present invention can be also applied to other one-way functions based on other problems. f(P) is a function that expands the length of a password P so that the password becomes an input value of the OWF, and it is not necessary for f(P) to have the encryption property. V(x) means a symmetric encryption of x with the key V, and V−1(x) means a symmetric decryption of x with the key V. Here, the symmetric-key encryption may be the well-known DES, 3DES, RC5, AES, etc. H( ) is a hash function such as sha-1, md5, etc., and ∥ means concatenation.

In FIG. 1, secret information of the user is only the password, and secret information of the server is a password verifier V=OWF(f(P)) for a respective user.

In FIG. 1, a user 50 sends to a server 60 (step 101) a message including a user ID ID_{User}, a test number A=OWF(r) computed by randomly selecting a random number x (step 101a), and a question number generation value X=V(g^{x}) known only to the server and the user and computed by randomly selecting the random number x (step 101b). Accordingly, the user and server authentication and key exchange protocol can be started.

The server 60, that has received the message from the user, sends to the user 50 (step 102) a message including an authentication Auth=H(K′∥1) of whether the server possesses a public key (step 102a) computed by randomly selecting the random number y using the message, and a question number generation value Y=V(g^{Y}) known only to the server and the user (step 102b). The authentication Auth=H(K′∥1) is computed using K=[V⁻¹(X)]^{y}, K′=H(K∥g^{x}∥g^{y}∥ID_{User}∥ID_{Server}). During the next procedure, this enables the user to compute the server authentication information and random challenge (i.e., ‘c’ at a step 103b).

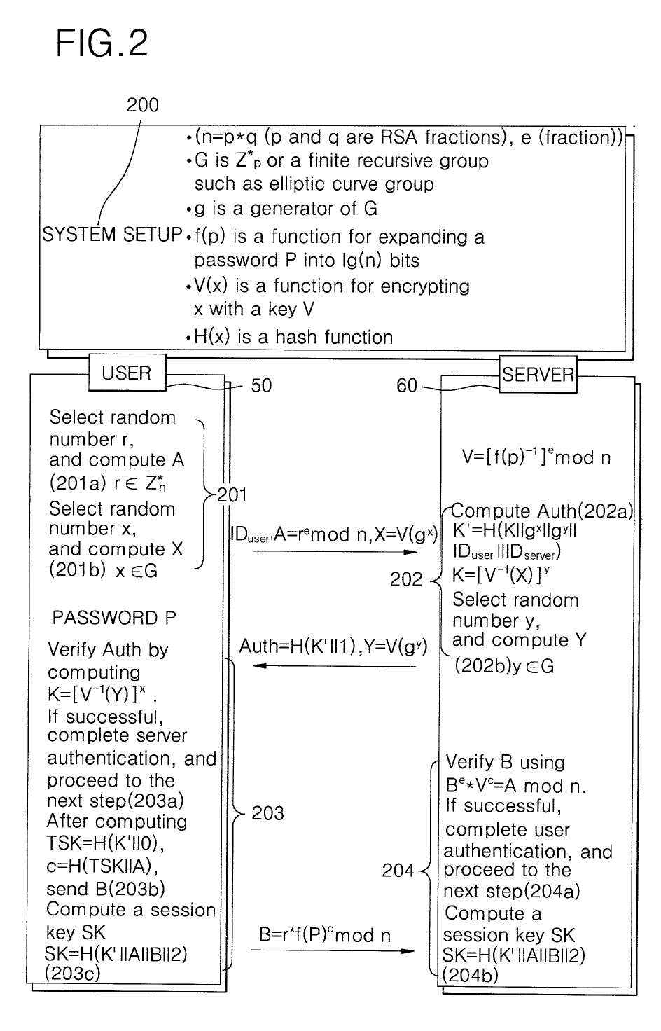

The user 50, that has received the message transmitted from the server 60 (step 102), verifies the authentication by computing K=[V⁻¹(Y)]^{x}, K′=H(K∥g^{x}∥g^{y}∥ID_{User}∥ID_{Server}). If the authentication succeeds as a result of verification, the user 50 can be convinced that the server knows the password verifier V. Thus, the user can complete the server authentication by confirming whether the server possesses the password verifier V (step 103a). Then, the user computes c=H(TSK∥A) using A and TSK=H(K′∥0). At this time, c becomes a result of a secret coin tossing, and in the general zero-knowledge proof, c is a value known only to the server and the user, being different from that transmitted from the server to the user in the form of a text. Also, the server that is the subject of performing the authentication makes the random challenge (i.e., c) transmitted from the server to the user that is the subject of performing the authentication request known only to the server and the user, and this can defend against the offline dictionary attack. In the same manner, protocols illustrated in FIGS. 2, 3, and 4, which will be explained later, can also defend against the offline dictionary attack by making the random challenge known only to the server and the user.

After the above computation, the user computes the witness number B using the above c, r, and password P that the user has, and sends the witness number B to the server (step 103b). Also, the user computes the session key SK by SK=H(K′∥A∥B∥2) (step 103c). Through the above three steps 103a to 103c, the user authenticates the server, and sends the witness number B.

The server 60 computes c=H(TSK∥A), and verifies the user's witness number B using A, V, and c. If the verification succeeds, the server completes the user authentication (step 104a). Then, the server computes the session key SK by SK=H(K′∥A∥B∥2) (step 104b). After the completion of this protocol, the session key SK exchanged between the user and the server is SK=H(K′∥A∥B∥2) (step 104).

FIG. 2 is a view illustrating a protocol for applying an RSA problem to the framework of FIG. 1. The system settings in FIG. 2 have the same meaning as those in FIG. 1, and the different portion (n=p*q, e) is an RSC public key. At this time, p and q are RSA fractions, e is a fraction, and thus the one-way function is OWF(r)=r^{e} mod n. f(P) is a function for expanding the password P into 1 g(n) bits (step 200).

In FIG. 2, the secret information of the user is only the password, and the secret information of the server is a password verifier V=[f(P)⁻¹]^{e} mod n for the respective user.

In FIG. 2, the user 50 sends to the server 60 (step 201) a message including a user ID ID_{User}, a test number A=r^{e} mod n computed by randomly selecting a random number x (step 201a), and a question number generation value X=V(g^{x}) known only to the server and the user and computed by randomly selecting the random number x (step 201b).

The server 60, that has received the message from the user, sends to the user 50 (step 202) a message including an authentication Auth=H(K′∥1) of whether the server possesses a public key (step 202a) computed by randomly selecting the random number y using the message, and a question number generation value Y=V(g^{y}) known only to the server and the user (step 202b). Meanwhile, Auth=H(K′∥1) is computed using K=[V⁻¹(X)]^{y}, K′−H(K∥g^{x}∥g^{y}∥ID_{User}∥ID_{Server}).

The user 50, that has received the message transmitted from the server 60 (step 202), verifies the authentication by computing K=[V⁻¹(Y)]^{x}, K′=H(K∥g^{x}∥g^{y}∥ID_{User}∥ID_{Server}). If the authentication succeeds as a result of verification, the user 50 can be convinced that the server knows the password verifier V. Thus, the user can complete the server authentication by confirming whether the server possesses the password verifier V (step 203a). Then, the user computes c=H(TSK∥A) using A and TSK=H(K′∥0). At this time, c becomes a result of a secret coin tossing, and in the general zero-knowledge proof, c is a value known only to the server and the user, being different from that sent from the server to the user in the form of a text. After the above computation, the user computes the witness number B using the above-described c, r, and password P that the user has, and sends the witness number B to the server (step 203b). At this time, the witness number B is B=r*f(P)^{c} mod n. Also, the user computes the session key SK by SK=H(K′∥A∥B∥2) (step 203c). Through the above three steps 203a to 203c, the user authenticates the server, and sends the witness number B.

The server 60 computes c=H(TSK∥A), and verifies the user's witness number B using B^{e}*V^{c}=A mod n. If the verification succeeds, the server completes the user authentication (step 204a). Then, the server computes the session key SK by SK=H(K′∥A∥B∥2) (step 204b). After the completion of this protocol, the session key SK exchanged between the user and the server is SK=H(K′∥A∥B∥2) (step 204).

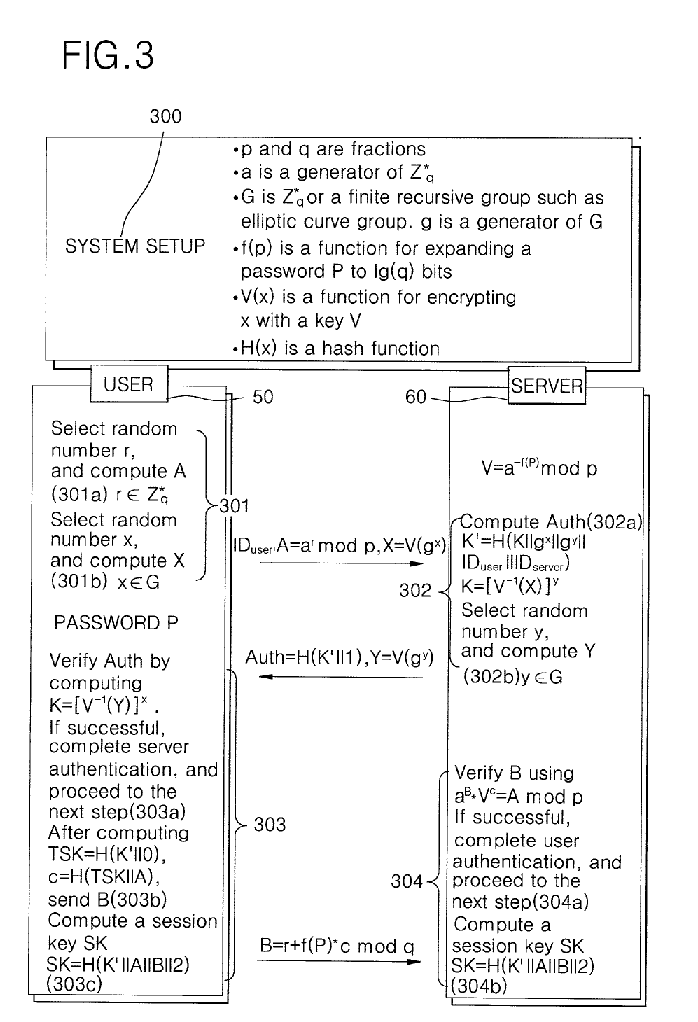

FIG. 3 is a view illustrating a protocol for applying a discrete logarithm problem to the framework of FIG. 1. The system settings in FIG. 3 have the same meaning as those in FIG. 1, and P is a fraction having a factor of q that is a fraction larger than p by p−1. a is a generator of Z*_{q}, and thus is OWF(r)=a^{r} mod p. f(P) is a function for expanding the password P into 1g(q) bits (step 300).

In FIG. 3, the secret information of the user is only the password, and the secret information of the server is a password verifier V=a^{-f(P)} mod p for the respective user.

In FIG. 3, the user 50 sends to the server 60 (step 301) a message including a user ID ID_{User}, a test number A=a^{r} mod p computed by randomly selecting a random number x (step 301a), and a question number generation value X=V(g^{X}) known only to the server and the user and computed by randomly selecting the random number x (step 301b).

The server 60, that has received the message from the user, sends to the user 50 (step 302) a message including an authentication Auth=H(K′∥1) of whether the server possesses a public key (step 302a) computed by randomly selecting the random number y using the message, and a question number generation value Y=V(g^{y}) known only to the server and the user (step 302b). Meanwhile, Auth=H(K′∥1) is computed using K=[V⁻¹(X)]^{y}, K′=H(K∥g^{x}∥g^{y}∥ID_{User}∥ID_{Server}).

The user 50, that has received the message transmitted from the server 60 (step 302), verifies the authentication by computing K=[V⁻¹(Y)]^{x}, K′=H(K∥g^{x}∥g^{y}∥ID_{User}∥ID_{Server}). If the authentication succeeds as a result of verification, the user 50 can be convinced that the server knows the password verifier V. Thus, the user can complete the server authentication by confirming whether the server possesses the password verifier V (step 303a). Then, the user computes c=H(TSK∥A) using A and TSK=H(K′∥0). At this time, c becomes a result of a secret coin tossing, and in the general zero-knowledge proof, c is a value known only to the server and the user, being different from that sent from the server to the user in the form of a text. After the above computation, the user computes the witness number B using the above-described c, r, and password P that the user has, and sends the witness number B to the server (step 303b). At this time, the witness number B is B=r+f(P)*c mod q. Also, the user computes the session key SK by SK=H(K′∥A∥B∥2) (step 303c). Through the above three steps 303a to 303c, the user authenticates the server, and sends the witness number B.

The server 60 computes c=H(TSK∥A), and verifies the user's witness number B using a^{B}*V^{c}−A mod p. If the verification succeeds, the server completes the user authentication (step 304a). Then, the server computes the session key SK by SK=H(K′∥A∥B∥2) (step 304b). After the completion of this protocol, the session key SK exchanged between the user and the server is SK=H(K′∥A∥B∥2) (step 304).

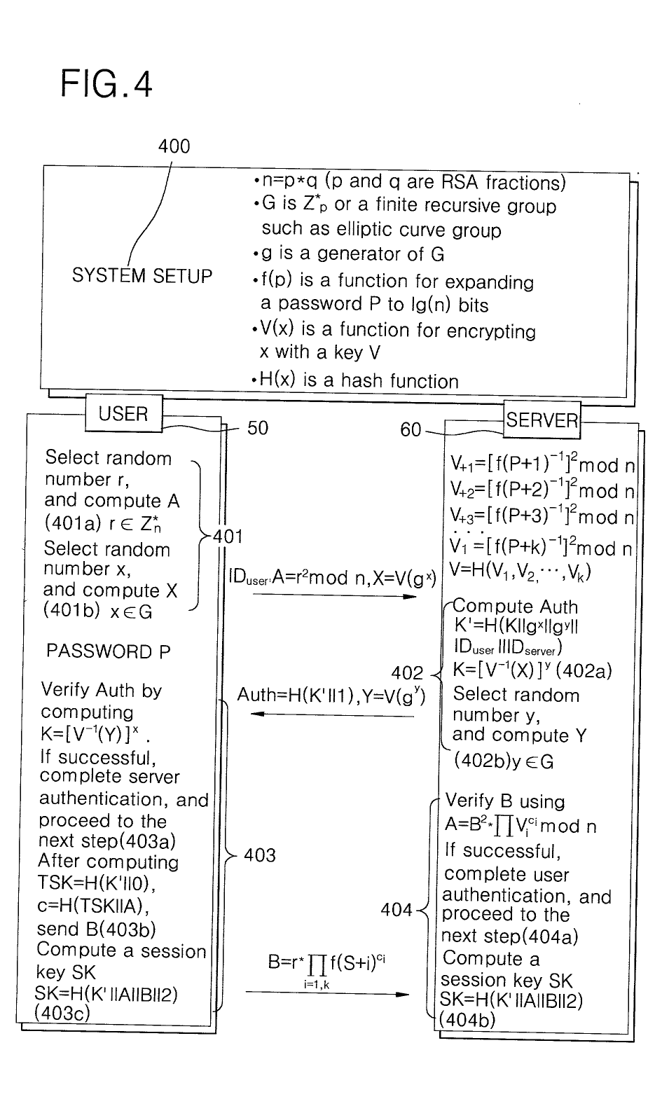

FIG. 4 is a view illustrating a protocol for applying a square root problem based on a prime factorization to the framework of FIG. 1. The system settings in FIG. 4 have the same meaning as those in FIG. 1, and the different portion (n=p*q) is an RSC public key. Thus, the one-way function is OWF(r)=r² mod n. f(P) is a function for expanding the password P into 1g(n) bits (step 400).

In FIG. 4, the secret information of the user is only the password, and the secret information of the server is a password verifier [V₁=[f(P+1)⁻¹]² mod n, V₂=[f(P+2)⁻¹]² mod n, V₃=[f(P+3)⁻¹]² mod n, . . . , Vₖ=[f(P+k)⁻¹]² mod n, V=H(V₁, V₂, . . . , Vₖ)] for the respective user.

In FIG. 4, the user 50 sends to the server 60 (step 401) a message including a user ID ID_{User}, a test number A=r² mod n computed by randomly selecting a random number x (step 401a), and a question number generation value X=V(g^{x}) known only to the server and the user and computed by randomly selecting the random number x (step 401b).

The server 60, that has received the message from the user, sends to the user 50 (step 402) a message including an authentication Auth=H(K′∥1) of whether the server possesses a public key (step 402a) computed by randomly selecting the random number y using the message, and a question number generation value Y=V(g^{y}) known only to the server and the user (step 402b). Meanwhile, Auth=H(K′∥1) is computed using K=[V⁻¹(X)]^{y}, K′=H(K∥g^{x}∥g^{y}∥ID_{User}∥ID_{Server}).

The user 50, that has received the message transmitted from the server 60 (step 402), verifies the authentication by computing K=[V−1(Y)]x, K′=H(K∥gx∥gy∥IDUser∥IDServer). If the authentication succeeds as a result of verification, the user 50 can be convinced that the server knows the password verifier V. Thus, the user can complete the server authentication by confirming whether the server possesses the password verifier V (step 403a). Then, the user computes c=H(TSK∥A) using A and TSK=H(K′∥0). At this time, c becomes a result of a secret coin tossing, and in the general zero-knowledge proof, c is a value known only to the server and the user, being different from that sent from the server to the user in the form of a text. After the above computation, the user computes the witness number B using the above-described c, r, and password P that the user has, and sends the witness number B to the server (step 403b). At this time, the witness number is given by

$$B = r * {\prod }_{i = l , k} {( f ( P + i ) )}^{{c}_{i}}$$

Also, the user computes the session key SK by SK=H(K′∥A∥B∥2) (step 403c). Through the above steps, the user authenticates the server, and sends the witness number B.

The server 60 computes c=H(TSK∥A), and verifies the user's witness number B using

$$A = {B}^{2} * \prod {V}_{i}^{{c}_{i}} mod n$$

If the verification succeeds, the server completes the user authentication (step 404a). Then, the server computes the session key SK by SK=H(K′∥A∥B∥2) (step 404b). After the completion of this protocol, the session key SK exchanged between the user and the server is SK=H(K′∥A∥B∥2) (step 404).

As described above, the present invention has the following effects.

First, the protocols designed according to the present invention can make a strong defense against the offline dictionary attacks.

Also, the present invention can be applied to the user authentication and key exchange protocol used in communication networks. For instance, it can be defined that the transport layer security (TLS), which is the transport layer security protocol established in the Internet engineering task force (IETF) and is used for the Internet information protection, is performed only by the password without the necessity of the note of authentication or secret key. Also, the present invention can be applied to the authentication protocol being discussed in the IEEE 802.11i group.

Also, the present invention can substitute for the user authentication procedure of UNIX.

In addition, a new authentication and key exchange protocol can be easily designed using the framework proposed in the present invention. Thus, a user can easily design a secure authentication and key exchange protocol even without a deep knowledge of encryption.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A method of designing a password-based authentication and key exchange protocol using a zero-knowledge interactive proof, comprising:
a first step of setting various kinds of system parameters required for authentication;
a second step of a user selecting a certain random number (r, x) in conformity with the set parameters, and sending to a server a message including a user ID, a test number (A=OWF(r)) to which a one-way function (OWF) is applied, and a first question number generation value X known only to the server and the user;
a third step of the server sending to the user a message including an authentication Auth of whether the server possesses a public key, and a second question number generation value Y known only to the server and the user;
a fourth step of the user authenticating the server by verifying the authentication Auth, computing a resultant value c of a secret coin tossing known only to the server and the user and a session key SK in a general zero-knowledge proof, and sending to the server a witness number B for user authentication; and
a fifth step of the server that stores a password verifier (V=OWF(f(P)) for the respective user verifying the witness number B using the test number A, the password verifier V, and the value c, and exchanging the session key SK by computing the session key SK.

2. The method as claimed in claim 1, wherein the witness number B is sent to the server using the value c, the random number r, and its own password P.

3. The method as claimed in claim 1, wherein the user authenticates the server by confirming whether the server possesses the password verifier.

4. The method as claimed in claim 1, wherein if the one-way function is based on an RSA problem, the password verifier is V=[f(P)⁻¹]^{e} mod n, where n=p*q(p and q are RSA fractions, e (fraction) is a public key, and f(P) is a function for expanding the password P into lg(n) bits.

5. The method as claimed in claim 1, wherein the witness number B is B=r*f(P)^{c} mod n, where c=H(TSK∥A), TSK=H(K′∥0), K=[V⁻¹(X)]^{y}, K=H(K∥g^{x}∥g^{y}∥ID_{User}∥ID_{Server}, and H( ) is a hash function.

6. The method as claimed in claim 1, wherein authentication of the witness number B is performed using B^{e}*V^{c}=A mod n, where c=H(TSK∥A), TSK=H(K′∥0), K=[V⁻¹(Y)]^{x}, and K′=H(K∥g^{x}∥g^{y}∥ID_{User}∥ID_{Server}).

7. The method as claimed in claim 1, wherein if the one-way function is based on a discrete logarithm problem, the password verifier is V=a^{-F(p)} mod p, where a is a generator of Z*_{q}, P is a fraction, and f(P) is a function for expanding the password P into lg(n) bits.

8. The method as claimed in claim 1, wherein the witness number is B=r+f(P)*c mod q, where c=H(TSK∥A), TSK=H(K′∥0), K=[V⁻¹(X)]^{y}, K′=H(K∥g^{x}∥g^{y}∥ID_{User}∥ID_{Server}, and H( ) is a hash function.

9. The method as claimed in claim 8, wherein authentication of the witness number B is performed using a^{B}V^{c}=A mod p, where c=H(TSK∥A), TSK=H(K′∥0), K=[V⁻¹(Y)]^{x}, and K′=H(K∥g^{x}∥g^{y}∥ID_{User}∥ID_{Server}).

10. The method as claimed in claim 1, wherein if the one-way function is based on a prime factorization problem, the password verifier is [V₁=[f(P+1)⁻¹]² mod n, V₂=[f(P+2)⁻¹]² mod n, V₃=[f(P+3)⁻¹]² mod n, . . . , V_{k=[f(P+k)}⁻¹]² mod n, V=H(V₁, V₂, . . . , Vₖ)], where n=p*q(p and q are RSA fractions), and f(P) is a function for expanding the password P into lg(n) bits.

11. The method as claimed in claim 1, wherein the witness number is
$$B = r * {\prod }_{i = l , k} {( f ( P + i ) )}^{{c}_{i}}$$
where c=H(TSK∥A), TSK=H(K′∥0), K=[V⁻¹(X)]^{y}, K′=H(K∥g^{x}∥g^{y}∥ID_{User}∥ID_{Server}, and H( ) is a hash function.

12. The method as claimed in claim 11, wherein authentication of the witness number B is performed using
$$A = {B}^{2} * \prod {V}_{i}^{{c}_{i}} mod n$$
where c=H(TSK∥A), TSK=H(K′∥0), K=[V⁻¹(Y)]^{x}, K′=H(K∥g^{x}∥g^{y}∥ID_{User}∥ID_{Server}, and c₁, is an i-th bit.

13. The method as claimed in claim 1, wherein the server makes a random challenge transmitted for authentication from the server to the user known only to the server and the user to defend against an offline dictionary attack.
